(19) United States
(12) Patent Application Publication
(10) Pub. No.: US 2011/0254470 A1
(43) Pub. Date: Oct. 20, 2011

(54) Collapsible Lighting Device

(76) Inventor: Gregory James Penoyer, Boston, MA (US)

(21) Appl. No.: 12/917,575

(22) Filed: Nov. 2, 2010

Related U.S. Application Data
(60) Provisional application No. 61/325,412, filed on Apr. 19, 2010.

(51) Int. Cl. H05B 37/02; F21L 4/02; F21V 5/00; F21S 4/00

(52) U.S. Cl. 315/313; 362/249.07; 362/183; 362/235

(57) ABSTRACT

A collapsible lighting device including a plurality of light panel sections, each light panel section comprising a plurality of light emitting elements, at least one connection element constructed and arranged to connect one or more light panel sections of the plurality of light panel sections to one another, and an electronic control system configured to distribute electrical power to the plurality of light emitting elements.

### RELATED APPLICATIONS

This application claims the benefit of U.S. Provisional Patent Application Ser. No. 61/325,412, filed on Apr. 19, 2010, the content of which is incorporated herein by reference in its entirety.

### TECHNICAL FIELD

The present invention generally provides an improved lighting device, and more particularly an improved lighting device of the type commonly used for temporary lighting.

### BACKGROUND OF THE INVENTION

Flashlights have been long known and widely used. Although simple flashlights have been generally effective for many required applications, such as illuminating small work areas in dimly lit locations with a generally large space envelope surrounding them. However, their abilities are often limited by size. Generally, whenever a larger area of illumination is required, a larger flashlight is required. When a larger flashlight is used, the space envelope around any particular work area is also required.

### SUMMARY OF THE INVENTION

A collapsible lighting device can solve many of the problems posed by conventional flashlights. Flashlights work well when a relatively small focused area of illumination is needed for a particular work area. They become limited when a wide area of illumination is required, such as the underside of an automobile or behind a piece of equipment for example. As flashlights typically only have one light bulb which is focused by a reflective lens, they typically only illuminate a small area. By utilizing a plurality of light emitting elements, a collapsible lighting device can illuminate a significantly larger work area.

This creates an additional improvement. Flashlights are generally are hard to position and hold in place when aiming the single beam of light at a particular work area. They require precise positioning to illuminate a desired area which can be difficult for a user, and sometimes can be impossible given the space envelope surrounding the work area. As the collapsible lighting device utilizes a plurality of light emitting elements to create a larger area of illumination, they do not require such precise positioning and aiming.

Although large arrays of light emitting elements can provide a larger area of illumination, a very large rigid device would be awkward and difficult to handle by a user. Also, portability and transportation concerns exist. By making the device collapsible, an end user can roll up or fold a large device into a compact and portable form. Then that user would be able to put the device in a tool box or bag and bring it to another work area. Further, collapsible lighting devices are capable of being temporarily expanded to produce a larger array of light, depending on the needs of a user at any particular time.

In addition, to improve on the userability of a lighting device, a collapsible lighting device can be designed to be thin and low profile so that it can be used in tight spaces like under an automobile or between a wall and a large piece of equipment. Further, a collapsible lighting device can be manufactured from flexible materials such that it does not require a large flat surface to be placed on, as often work areas are not conducive to large, flat, stable surfaces. To compliment the thin design, a collapsible lighting device can be designed with mounting tabs and magnets built in to allow for temporary positioning in a variety of applications.

In one aspect, a collapsible lighting device comprises: a plurality of light panel sections, each light panel section comprising a plurality of light emitting elements; at least one connection element constructed and arranged to connect one or more light panel sections of the plurality of light panel sections to one another; and an electronic control system configured to distribute electrical power to the plurality of light emitting elements.

In one embodiment, the electronic control system comprises an on/off switch.

In another embodiment, the electrical power supply comprises a rechargeable battery pack.

In another embodiment, the at least one connection element comprises a rotating hinge.

In another embodiment, the at least one connection element comprises a multi-position rotating joint.

In another embodiment, the at least one connection element comprises a flexible material joint.

In another embodiment, a light panel section of the plurality of light panel sections comprises a base material and a lens material, wherein the plurality of light emitting elements of the light panel section are positioned between the base material and the lens material.

In another embodiment the collapsible lighting device further comprises mounting tabs attached to the light panel.

In another embodiment, the collapsible lighting device further comprises magnetic components for mounting.

In another embodiment, the base material comprises one or materials selected from the group consisting of: rubber, plastic, polyurethane, vinyl, nylon, composite, textile, and metals.

In another embodiment, the lens material comprises one or materials selected from the group consisting of: rubber, plastic, polyurethane, vinyl, nylon, composite, textile, and metals.

In another embodiment, the connection element constructed and arranged to connect one or more light panel sections of the plurality of light panel sections to one another can be decoupled.

In another aspect, a collapsible lighting device comprises: a flexible light panel section that can be rolled up; a plurality of light emitting elements; an electrical power source; and an electronic control system configured to distribute electrical power to the plurality of light emitting elements.

In one embodiment, the flexible light panel section comprises a flexible base material and a flexible lens material, wherein the plurality of light emitting elements of the flexible light panel section are positioned between the flexible base material and flexible lens material.

In another embodiment, the electronic control system comprises an on/off switch.

In another embodiment, the electrical power source comprises a rechargeable battery pack.

In another embodiment, the collapsible lighting device further comprises mounting tabs attached to the light panels.

In another embodiment, the collapsible lighting device further comprises magnetic components for mounting.

In another embodiment, the flexible base material comprises one or materials selected from the group consisting of: rubber, plastic, polyurethane, vinyl, nylon, composite, textile, and metals.

In another embodiment, flexible lens material comprises one or materials selected from the group consisting of: rubber, plastic, polyurethane, vinyl, nylon, composite, textile, and metals.

In another embodiment, the collapsible lighting device comprises light emitting elements which are positioned and directed in opposing directions to allow multi-directional illumination.

### BRIEF DESCRIPTION OF THE DRAWINGS

The foregoing and other objects, features and advantages of embodiments of the present inventive concepts will be apparent from the more particular description of preferred embodiments, as illustrated in the accompanying drawings in which like reference characters refer to the same elements throughout the different views. The drawings are not necessarily to scale, emphasis instead being placed upon illustrating the principles of the preferred embodiments.

FIG. 1 is a perspective view of a fully expanded lighting device in accordance with embodiments of the present inventive concepts.

FIG. 2 is a perspective view of an individual light panel in accordance with embodiments of the present inventive concepts.

FIG. 3 is a perspective view of an individual light panel in accordance with other embodiments of the present inventive concepts.

FIG. 4 is a perspective view illustrating a method of collapsing a lighting device in accordance with embodiments of the present inventive concepts.

FIG. 5 is a perspective view illustrating a method of collapsing a lighting device in accordance with other embodiments of the present inventive concepts.

FIG. 6 is a perspective view of a flexible lighting device in accordance with embodiments of the present inventive concepts.

FIG. 7 is a perspective view illustrating a method of mounting a lighting device in accordance with embodiments of the present inventive concepts.

FIG. 8 is a perspective view illustrating a method of mounting a lighting device in accordance with other embodiments of the present inventive concepts.

### DETAILED DESCRIPTION OF EMBODIMENTS

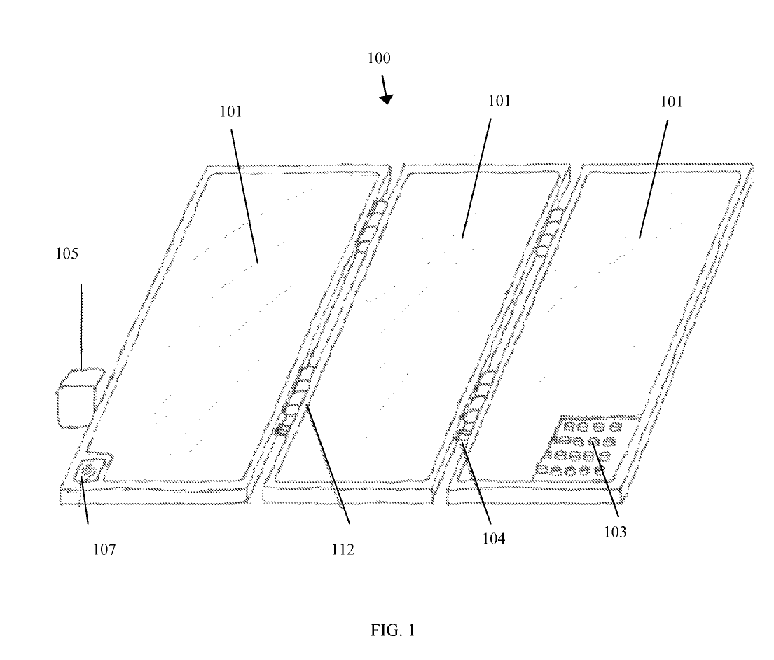

FIG. 1 is a perspective view of a fully expanded lighting device. A lighting device 100 can comprise one or more light panels 101 each having a plurality of light emitting elements 103. The light emitting elements 103 of the light panels 103 can be powered by an electrical power source 105, such as, a rechargeable battery pack comprising one or more individual batteries, a solar power panel, a fuel cell, or an internal electrical generator. In another embodiment, the light emitting elements 103 of the light panels 101 can be powered by AC electrical power.

The lighting device 100 can further comprise an electronic control system 107 that is configured to control the distribution of electrical power to the light emitting elements 103 of the one or more light panels 101. In one embodiment, the electronic control system 107 comprises a simple on/off operational switch or a control dial. Further, the electronic control system 107 can comprise an LED driver circuit that can manage and distribute electrical power to the light emitting elements 103.

In one embodiment, the one or more light panels 101 can be connected to one another by hinges 112. However, in another embodiment, the light panels 101 can be connected to one another by a rotational joint or a flexible material, such as, rubber or plastic. Further, the one or more light panels 101 can be electrically connected to one another by a wire harness 104. The wire harness 104 can comprise one or more conductors from the group of conductors comprising: ribbon cable, coaxial cable, twisted wire. However, in another embodiment, electrical connections can be built into the hinge mechanism 112. As such, the wire harness 104 or hinge 112 can distribute electrical power to each of the one or more light panels 101 of the lighting device 100.

In one embodiment the light panels 101 can be decoupled at the hinges 112 to add or remove light panels from the lighting device 100. In another embodiment, the light panels 101 can be permanently coupled to one another at the hinges 112.

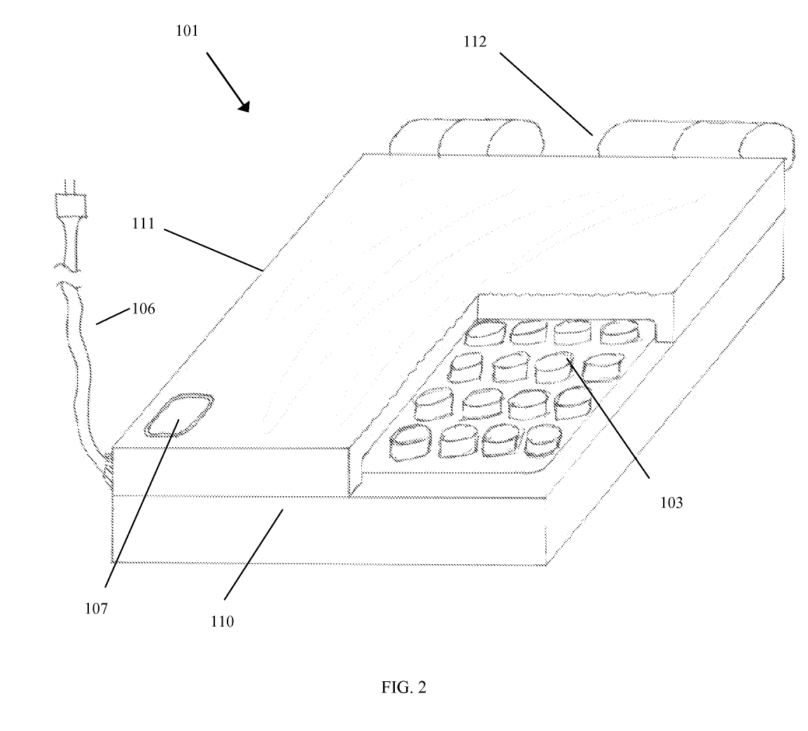

FIG. 2 is a perspective view of an individual light panel. A light panel 101 can comprise a plurality of light emitting elements 103 that are positioned between a base material 110 and a lens material 111. The base material 110 and the lens material 111 can comprise materials that protect inner components from debris and/or damage. The base material 110 can comprise one or more materials selected from the group of materials comprising: metals, plastics, acrylics, composites and glass. The lens material 111 can comprise one or more materials selected from the group of materials comprising: plastics, acrylics, and glass. In one embodiment, the base material 110 and the lens material 111 comprise the same material. Further, the lens material 111 can comprise a translucent material or a transparent material, and the base material 110 can comprise a translucent material, a transparent material, a reflective material or an opaque material.

The light emitting elements 103 can comprise one or more light emitting diodes (LEDs). However, in other embodiments, the light emitting elements 103 can comprise one or more, incandescent lighting elements, fluorescent lighting elements, organic light emitting diodes (OLEDs) or liquid crystal displays (LCDs).

In this exemplary embodiment, electrical power is provided to the light emitting elements 103 of the light panel 101 by a power cord 106, which can be connected to an external AC electrical outlet. However, in other embodiments, electrical power can be provided to the light emitting elements 103 of the light panels 101 by an electrical power source, such as, the electrical power source 105 in FIG. 1.

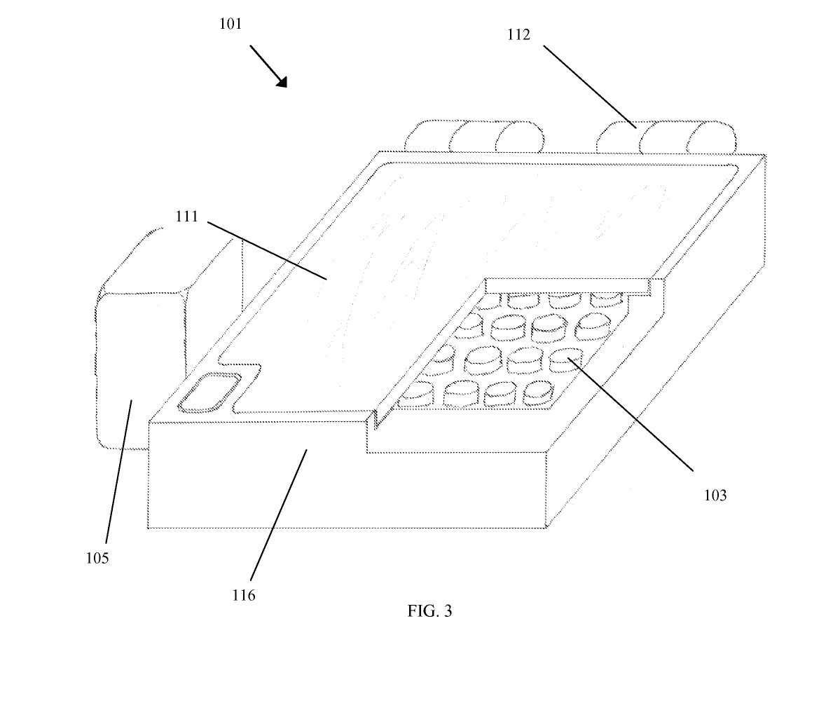

FIG. 3 is a perspective view of an individual light panel. A light panel 101 can comprise a plurality of light emitting elements 103 that can be housed in a rigid chassis 116. The light emitting elements 103 of the rigid chassis 116 can be covered with a lens material 111. The light emitting elements 103 can be powered by an electrical power source 105 and can further be controlled by an electronic control system 107.

The rigid chassis 116 and lens material 111 can comprise a material which has sufficient material properties to protect the inner components from debris and/or damage. The chassis 116 can comprise one or more materials selected from the group of materials comprising: metals, plastics, acrylics, composites and glass. The lens material 111 can comprise one or more materials selected from the group of materials comprising: plastics, acrylics, and glass. In one embodiment, the chassis 116 and the lens material 111 comprise the same material. Further, the lens material 111 can comprise a translucent material or a transparent material, and the chassis 116 can comprise a translucent material, a transparent material, a reflective material or an opaque material.

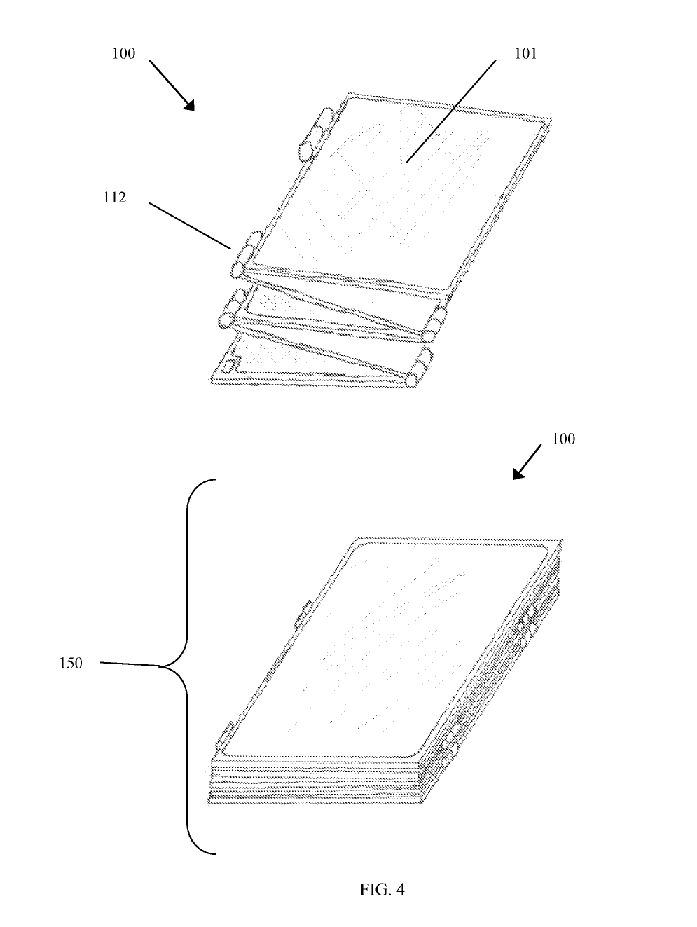

FIG. 4 is a perspective view illustrating a method of collapsing a lighting device 100. A lighting device comprising a plurality of light panels 101 can be collapsed according to an accordion-type method, which allows a lighting device 100 comprising two or more individual light panels 101 to be fully collapsed into a stack 150.

In this exemplary embodiment, a plurality of light panels 101 are connected to one another by hinges 112. In this manner, the plurality of light panels 101 can be collapsed, wherein one light panel is folded onto an adjacent light panel.

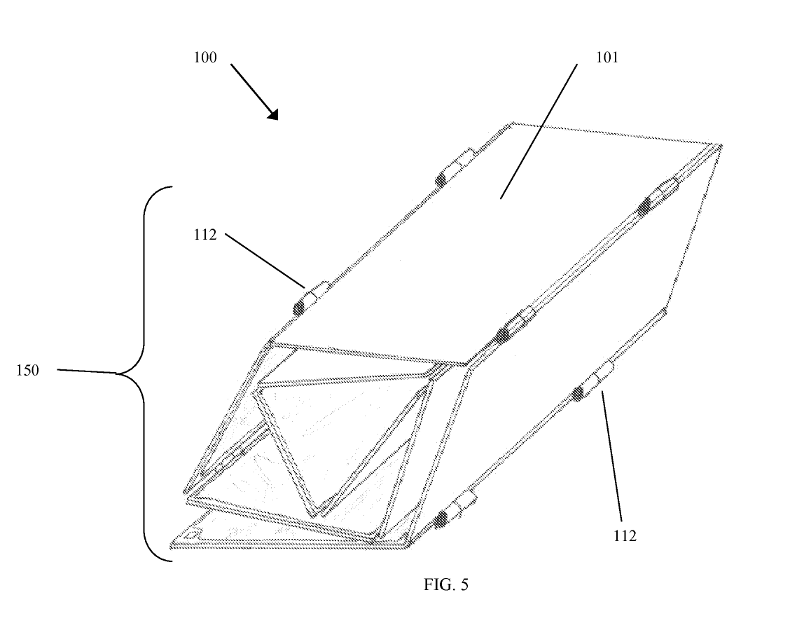

FIG. 5 is a perspective view illustrating a method of collapsing a lighting device 100. A lighting device comprising a plurality of light panels 101 can be collapsed according to a roll-up method, which allows a lighting device 100 comprising two or more individual light panels 101 to be collapsed into a roll 151.

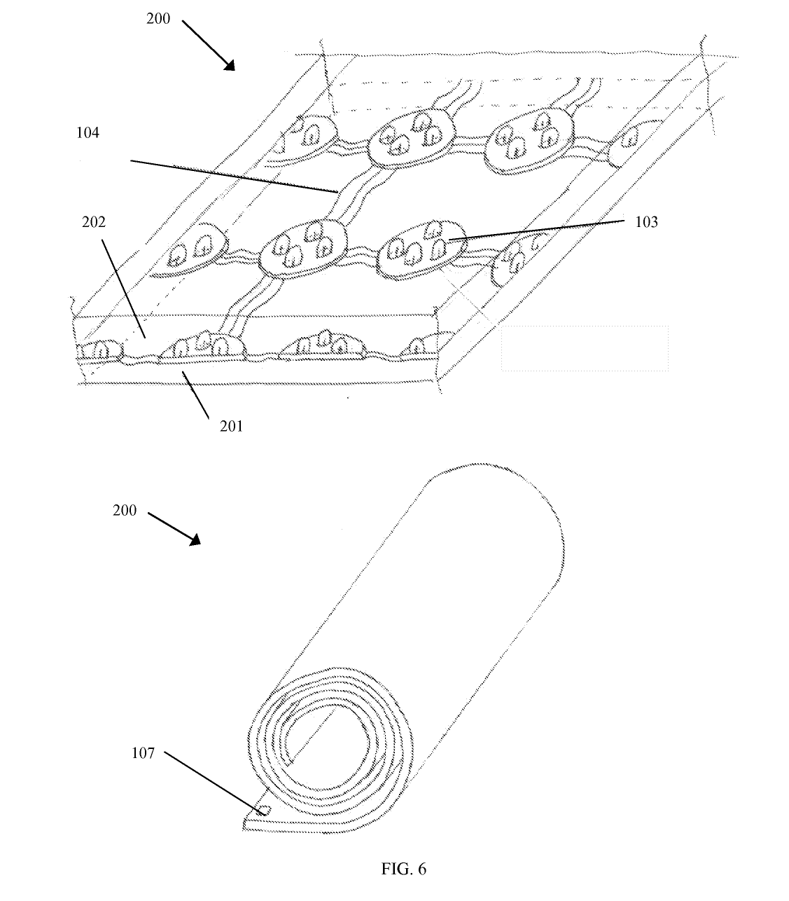

FIG. 6 is a perspective view of a flexible lighting device 200. A flexible lighting device 200 can comprises a plurality of light emitting elements 103 encased between a flexible base material 201 and a flexible lens material 202, and can be controlled by an electronic control system 107. In one embodiment, electrical power can be provided to the flexible lighting device 200 by a power source 105 or an electrical cord 106.

The light emitting elements 103 can be circular in shape, and can comprise one or more individual light emitting elements, however, in other embodiments the light emitting elements 103 can be any shape that is desired for additional functional or aesthetic requirements. For example, the light emitting elements 103 can be rectangular, triangular, or long thin strips. Light emitting elements 103 can be spaced apart from adjacent light emitting elements 103 such that if light modules are rigid, the entire flexible lighting device maintains flexibility and may be rolled up. Depending on the size of the light emitting elements 103, a space between adjacent modules can be optimized for maximum lighting. For example, larger more powerful light emitting elements 103 may require larger space between adjacent light emitting elements 103 to prevent the flexible lighting device 200 from becoming a rigid mat of light emitting elements 103. Further, light emitting elements 103 can be connected to one another electrically by a wire harness 104. Light emitting elements 103 can be positioned facing different directions to provide multi directional illumination.

In this exemplary embodiment, the flexible base material 201 can comprise one or more materials selected from the group of materials comprising: plastics, polyurethane, vinyl, and rubber. The flexible lens material 202 can comprise one or more materials selected from the group of materials comprising: plastics, polyurethane, vinyl, and rubber. In one embodiment, the flexible base material 201 and the flexible lens material 202 can comprise the same material. However, in other embodiments the flexible base material 201 and the flexible lens materials 202 can be different materials. Further, the flexible lens material 202 can comprise a translucent material or a transparent material, and the flexible base material 201 can comprise a translucent material, a transparent material, a reflective material or an opaque material.

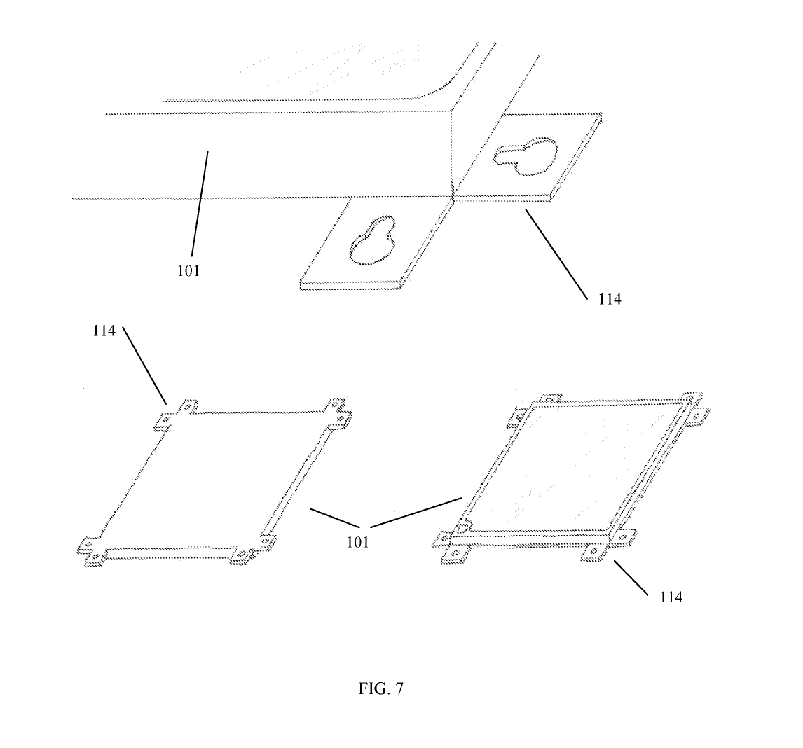

FIG. 7 is a perspective view illustrating a method of mounting a lighting device 100. A light panel 101 can comprise a plurality of mounting tabs 114, which can be used to hang or position the lighting device 100. In one embodiment, the mounting tabs 114 can be manufactured as part of a light panel 101. However, in other embodiments, the mounting tabs 114 can be separate components which can be attached to the light panel 101.

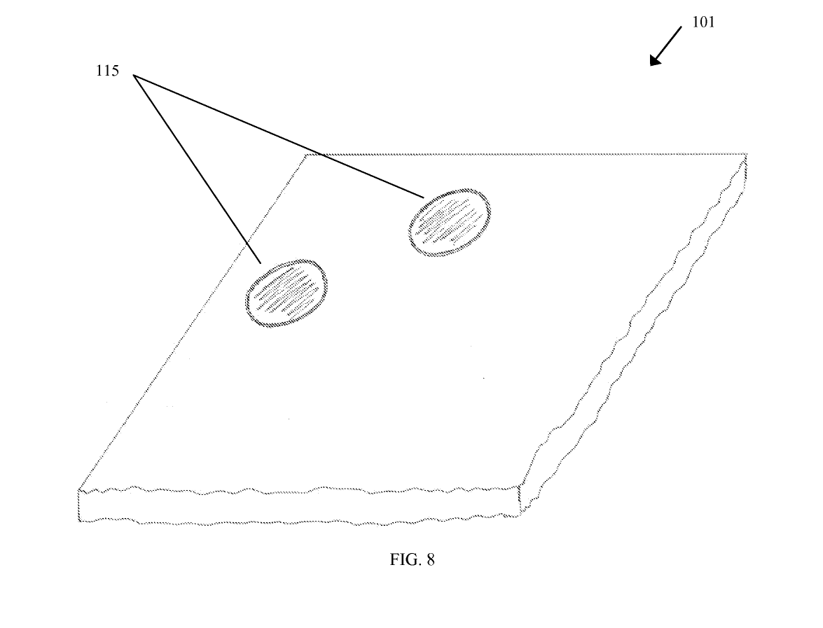

FIG. 8 is a perspective view illustrating a method of mounting a lighting device 100. A light panel 101 can comprise a plurality of mounting magnets 115, which can be used to hang or position the lighting device 100 in a variety of applications. In one embodiment, the mounting magnets 115 can be manufactured and molded into any one of the material housings, such as, the base material 110 or lens material 111. In other embodiments the mounting magnets 115 can be connected to the light panel 101 by a press fit friction joint or adhesive bonded to either the base material 110 or lens material 111.

What is claimed is:

1. A collapsible lighting device comprising:
a plurality of light panel sections, each light panel section comprising a plurality of light emitting elements;
at least one connection element constructed and arranged to connect one or more light panel sections of the plurality of light panel sections to one another; and
an electronic control system configured to distribute electrical power to the plurality of light emitting elements.

2. The collapsible lighting device of claim 1, wherein the electronic control system comprises an on/off switch.

3. The collapsible lighting device of claim 1, wherein the electrical power source comprises a rechargeable battery pack.

4. The collapsible lighting device of claim 1, wherein the at least one connection element comprises a rotating hinge.

5. The collapsible lighting device of claim 1, wherein the at least one connection element comprises a multi-position rotating joint.

6. The collapsible lighting device of claim 1, wherein the at least one connection element comprises a flexible material joint.

7. The collapsible lighting device of claim 1, wherein a light panel section of the plurality of light panel sections comprises a base material and a lens material, wherein the plurality of light emitting elements of the light panel section are positioned between the base material and the lens material.

8. The collapsible lighting device of claim 1 further comprising mounting tabs attached to the light panel

9. The collapsible lighting device of claim 1 further comprising magnetic components for mounting.

10. The collapsible lighting device of claim 1, wherein the base material comprises one or materials selected from the group consisting of: rubber, plastic, polyurethane, vinyl, nylon, composite, textile, and metals.

11. The collapsible lighting device of claim 1, wherein the lens material comprises one or materials selected from the group consisting of: rubber, plastic, polyurethane, vinyl, nylon, composite, textile, and metals.

12. The collapsible lighting device of claim 1, wherein the connection element constructed and arranged to connect one or more light panel sections of the plurality of light panel sections to one another can be decoupled.

13. A collapsible lighting device comprising:
a flexible light panel section that can be rolled up;
a plurality of light emitting elements;
an electrical power source;
and an electronic control system configured to distribute electrical power.

14. The collapsible lighting device of claim 13, wherein the flexible light panel section comprises a flexible base material and a flexible lens material, wherein the plurality of light emitting elements of the flexible light panel section are positioned between the flexible base material and the flexible lens material.

15. The collapsible lighting device of claim 13, wherein the electronic control system comprises an on/off switch.

16. The collapsible lighting device of claim 13, wherein the electrical power source comprises a rechargeable battery pack.

17. The collapsible lighting device of claim 13 further comprising mounting tabs attached to the light panels.

18. The collapsible lighting device of claim 13 further comprising magnetic components for mounting.

19. The collapsible lighting device of claim 13, wherein the flexible base material comprises one or materials selected from the group consisting of: rubber, plastic, polyurethane, vinyl, nylon, composite, textile, and metals.

20. The collapsible lighting device of claim 13, wherein the flexible lens material comprises one or materials selected from the group consisting of: rubber, plastic, polyurethane, vinyl, nylon, composite, textile, and metals.
